(19) United States
(12) Patent Application Publication
(10) Pub. No.: US 2013/0114584 A1
(43) Pub. Date: May 9, 2013

(54) METHOD FOR ESTABLISHING A BRIDGE CONNECTION AMONG WIRELESS ACCESS POINTS

(71) Applicant: Wen-Min HUANG, Taoyuan County (TW)

(72) Inventor: Wen-Min HUANG, Taoyuan County (TW)

(73) Assignee: DELTA ELECTRONICS, INC., Taoyuan County (TW)

(21) Appl. No.: 13/468,463

(22) Filed: May 10, 2012

(30) Foreign Application Priority Data
Nov. 7, 2011 (TW) 100140510

(51) Int. Cl. H04W 48/20; H04W 24/00; H04W 84/02

(52) U.S. Cl. 370/338

(57) ABSTRACT

A method for establishing a bridge connection among wireless access points is disclosed. A sharing group comprises multiple wireless access points (APs) within a specific distance. When a main wireless AP of the sharing group is enabled to connect to a destination website, the main wireless AP sends the data of the destination website and a test request to all wireless APs joining the sharing group. Each wireless AP individually tests connection spends to the destination website and reports to the ma establish a bridge connection in wireless AP. Accordingly, electronic device of users use the main wireless AP to a preferred wireless AP of the sharing group which has the fastest connection speed and connect to the destination website via the internet service provider used by the preferred wireless AP.

### BACKGROUND OF THE INVENTION

1. Field of the Invention

The present invention relates to a connection method, in particular it relates to a plurality of wireless access points having bridge connections among each other in order to bridge to the wireless access point which has the fastest connection speed to the website.

2. Description of Prior Art

In recent years, the technologies of the internet develop rapidly, the internet has become more and more popular as using internet is made convenient and the connection speeds increases exponentially. In addition, the population of internet users also continues to grow along with the development.

FIG. 1 is a schematic diagram of network connection architecture according to the prior art. Generally, when users want to connect to internet, it is required to prepare a first electronic device 11 (for example, a computer) having network connection function, a first wireless access point (Access Point, AP) 12, and a first modem 13. The first electronic device 11 wirelessly accesses the first wireless AP 12 to connect to an internet service provider (ISP) 14 subscribed by the users via the first modem 13. The users connect to the internet via the ISP 14 and browse the content of a website 15 on the internet with the first electronic device 11.

It should be mentioned that currently most of the first electronic devices 11 use wireless network card to wirelessly access to the first wireless AP 12 for connecting to the first modem 13. However, the first electronic device 11 may also be electrically connected to the first modem 13 with a network cable so as to make it more convenient to users.

Nonetheless, the total user count of different ISPs 14 varies and the internet using behaviors and user characteristics also different. For example, if users of an ISP_A use internet in the morning, the connection speeds provided by the ISP_A in the morning is lower than the connection speeds provided in the evening. In another example, if the users of an ISP_B use internet services in the evening mostly, the connection speeds provided by the ISP_B is very likely higher than the connection speeds provided by the ISP_A in the morning.

In addition, the websites on the internet are established in servers provided by different ISPs, depending on the website builders. The ISP used may be different from website to website. The connection speeds to the same destination website from the users via different ISPs also different.

Normally, a user signs up with one ISP service provider for connecting to the internet. Users are not given solutions but accepting the service as it is when the connection speeds become slower or a network traffic jam occurs and users' right are not guaranteed.

As mentioned above, it is desired in the market to provide an innovative connection method such that when the connection speeds provided by the ISP are too slow users are allowed to automatically or manually bridge to another wireless AP and connect to the internet.

### SUMMARY OF THE INVENTION

The objective of the present invention is to provide a method for establishing a bridge connection among wireless access points to establish bridge connections among multiple wireless access points. Thus, when the connection speeds of the ISP used by a wireless access point becomes too slow or a network traffic jam occurs as a result of network traffic jam, the wireless access point establish a bridge connection to another wireless access point having higher connection speeds and connects to the destination website via the other ISP used by the other wireless access point.

To accomplish the above objectives, a sharing group comprises multiple wireless access points (APs) within a specific distance is provided according to the present invention. When a main wireless AP of the sharing group is enabled to connect to a destination website, the main wireless AP sends data of the destination website and a test request to all wireless APs of the sharing group. The wireless APs of the sharing group individually tests connection speeds of the connection to the destination website and reports to the main wireless AP. The electronic device of the user uses the main wireless AP to establish a bridge connection with a preferred wireless AP of sharing group having the fastest connection speed to connect to the destination website via the ISP used by the preferred wireless AP.

Different wireless APs may use different ISPs and using different ISP to connect to different results in different connection speeds. Compare with the prior art, the advantage achieved by the present invention is that the method of the present invention allows multiple wireless APs to establish bridge connection among each others. When the connection speeds of the ISP used by a wireless AP to the destination website become too slow, the main AP establishes a bridge connection to the other wireless AP having faster connection speed, and connect to the internet via the ISP used by the other wireless AP.

Further, when there are too many users of the ISP used by the wireless AP using the ISP service which lead to network traffic jam, the wireless AP can establish a bridge connection to a wireless AP according to the method of the present invention, and connect to the internet via the other wireless AP using the other ISP.

As mentioned above, given any reasons leading to slow connection speeds or ISP service interruption, users can establish a bridge connection to the wireless AP having higher connection speeds and better service status according to the method of the present invention [symbol] method to connect to the internet with the other ISP different from the services using at the time.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of network connection architecture according to the prior art;

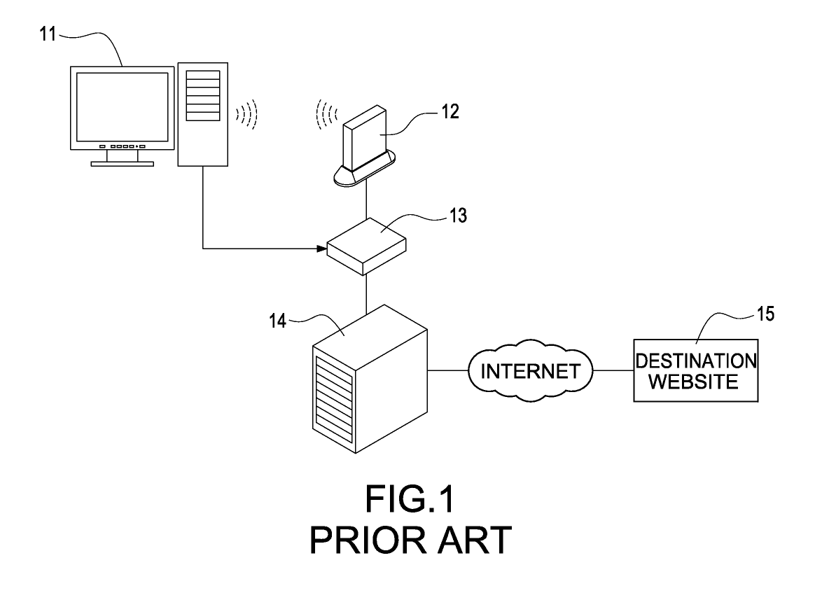

FIG. 2 is a schematic diagram of the other network connection architecture according to the prior art;

FIG. 3 is a schematic diagram of connection architecture according a preferred embodiment of the present invention;

FIG. 4 is a schematic diagram of a sharing group according a preferred embodiment of the present invention;

FIG. 5 is a flowchart according the first preferred embodiment of the present invention;

FIG. 6 is a flowchart according the second embodiment of the present invention; and

FIG. 7 is a flowchart seventh according the third embodiment of the present invention.

### DETAILED DESCRIPTION OF THE INVENTION

In cooperation with attached drawings, the technical contents and detailed description of the present invention are described thereinafter according to a preferable embodiment.

Generally speaking, users sign up service contract with internet service provider (ISP) depending on the their requirements such as the demanding service time periods, the geographic locations and fee rates for using the internet connection service provided by the ISPs. The connection speeds of each ISP are subject to the time periods, locations and the destination websites. Users are advised to take the above factors into accounts and choose an ISP which best suits the demands.

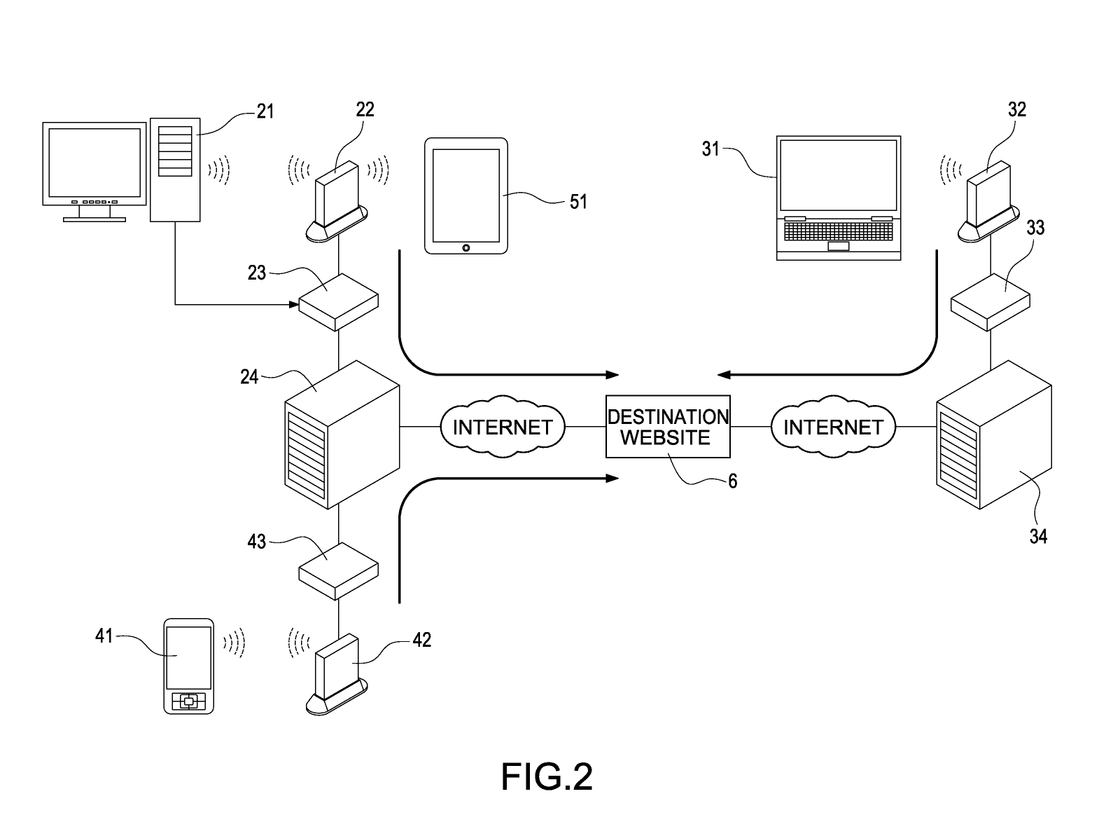

FIG. 2 is a schematic diagram of the other network connection architecture according to the prior art. For example, a user provides a second electronic device 21 having a wireless network card for wirelessly accessing to a second wireless access point (AP) 22, and connecting to a second modem 23 via the second wireless AP 22. The second modem 23 connects to a second ISP 24 which the user signs up the contract with via a telephone network or an optical network. The user controls the second electronic device 21 to connect to a destination website 6 via internet service provided by the second ISP 24.

The users also wirelessly accesses a third wireless AP 32 via a third electronic device 31 and connects to a third modem 33 via the third wireless AP 32. The third modem 33 connects to a third ISP 34 which the user also signs up the contract with. The user controls the third electronic device 31 for using the internet service provided by the third ISP 34 to connect to the internet.

Typically, an ISP serves a plurality of users depending on the bandwidth of the ISP. For example, the above second ISP 24 provides internet service to the user of the second electronic device 21, as well as to the user of a fourth electronic device 41 via a fourth modem 43 and a fourth wireless AP 42. In the embodiment, the second ISP 24 provides services to two users. Yet, it is known to people who skill in the art that an ISP is able to provide internet service to a great number of users and is not limited thereto.

It should be mentioned that, each electronic device can be electrically connected to a modem for reducing the cost of providing a wireless AP. However, a wireless AP is more convenient to use and provides better scalability. As demonstrated in the FIG. 2, the second wireless AP 22 wirelessly connects to the second electronic device 21 such that the second electronic device 21 is able to wirelessly access to the second wireless AP 22. The second wireless AP 22 also wirelessly connects to a fifth electronic device 51 such that the fifth electronic device 51 is able to wirelessly access to the second wireless AP 22.

In the embodiment, the second wireless AP 22 provides services to two electronic devices. However, a wireless AP is capable of wirelessly connecting to a great number of electronic devices sharing the limited network bandwidth. With the user's consent, a wireless AP may connect to unlimited number of electronic devices.

As shown in FIG. 2, the users of the second electronic device 21, the fourth electronic device 41 and the fifth electronic device 51 sign up the contracts with the second ISP 24, and the user of the third electronic device 31 signs up the contract with the third ISP 34. Given there are too many users using the service of the second ISP 24 and the connection speeds are slow as a result of insufficient network bandwidth. The users do not have other choices but connecting to the internet via the second ISP 24. Similarly, when connection speeds of the connection provided by the third ISP 34 are slow, the third electronic device 31 do not have other choices but connecting to the third modem 33 via the third wireless AP 32 for using the internet service provided by the third ISP 34.

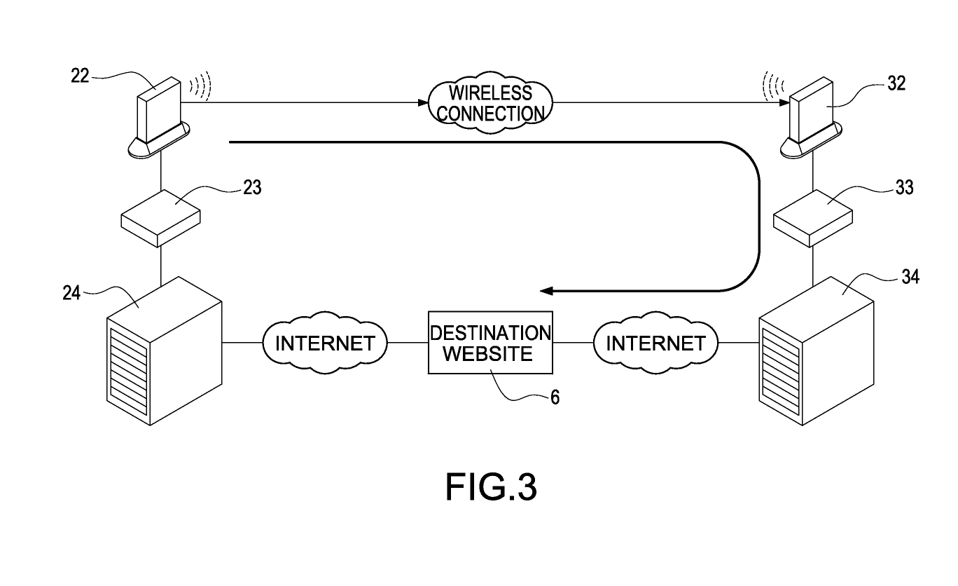

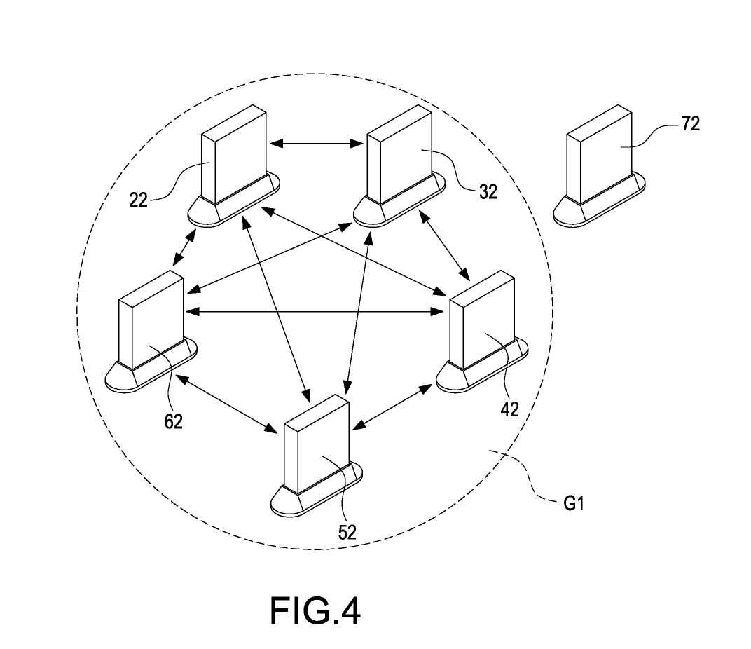

FIG. 3 is a schematic diagram of connection architecture according a preferred embodiment of the present invention and FIG. 4 is a schematic diagram of a sharing group according a preferred embodiment of the present invention. A method for establish a bridge connection among wireless APs is demonstrated in FIG. 4. As shown in the diagram, a sharing group G1 comprises main multiple wireless APs (including the second wireless AP 22, the third wireless AP 32, fourth wireless AP 42, the fifth wireless AP 52, and the sixth wireless AP 62 in FIG. 4). All wireless APs 22, 32, 42, 52, 62 of the sharing group G1 can establish a bridge connection among each other (detailed in the following).

As shown in FIG. 3, the bandwidth of the second ISP 24 is insufficient and results in that connection speeds of the connection provided by the second ISP 24 are slow, or connection speeds of the connection provided by the second ISP 24 to the destination website 6 is inherently slow. Under the circumstances, the users can establish a bridge connection to the other wireless AP of the sharing group G1, for example, the third wireless AP 32, via the second wireless AP 22 to connect to the internet via the third ISP 34 used by the third wireless AP 32. Thus, users connect to the destination website 6 with the connection speed faster than the connection speed provided by the second ISP 24. Nonetheless, the conditions are the connection speeds of the connection provided by the third ISP 34 is in fact faster than the connection provided by the second ISP 24, also the third wireless AP 32 and the second wireless AP 22 join the same sharing group G1.

In the embodiment, each wireless AP 22, 32, 42, 52, 62 have bridge function and a bandwidth sharing protocol, also within a specific distance to transmit/receive signals. As shown in FIG. 4, a seventh wireless AP 72 does not join the sharing group G1. Either the seventh wireless AP 72 does not have the bandwidth sharing protocol and the bridge function, or the distance between the seventh wireless AP 72 and the sharing group G1 is too long, therefore the seventh wireless AP 72 joins the other sharing group (not shown in the diagram). Under the circumstance, given the second ISP 24 has network traffic jam, the second wireless AP 22 is not able to establish a bridge connection to the seventh wireless AP 72, and is not able to connect to the internet via the ISP used by the seventh wireless AP 72.

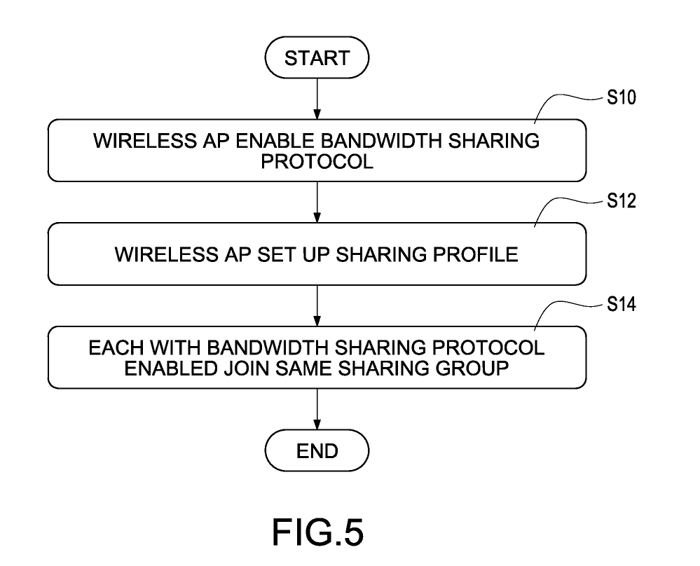

FIG. 5 is a flowchart according the first preferred embodiment of the present invention. Firstly, each wireless AP 22, 32, 42, 52, 62 was configured to enable the bandwidth sharing protocol for performing the method of establishing a bridge connection according to the present invention (step S10). Each wireless AP 22, 32, 42, 52, 62 is designed to provide the wireless connection function. Accordingly, it is only required to make some firmware change instead of hardware changes in order to enable the bridge connection function of the wireless APs 22, 32, 42, 52, 62 by enabling the bandwidth sharing protocol. As a result, the wireless APs 22, 32, 42, 52, 62 are able to establish a bridge connection according to the method of the present invention without interfering the wireless access service operation.

Also, each wireless AP 22, 32, 42, 52, 62 individually sets up the sharing profile after the step S10 so as to assure that, after the bandwidth sharing protocol is enabled, the bandwidth used by itself is not allocated totally to the bridging wireless AP which results in slow connection speeds (step S12). The sharing profile of each wireless AP 22, 32, 42, 52, 62 can be the sharing bandwidth percentage (for example 30% of the bandwidth), or the sharing bandwidth traffic (for example sharing 300 Mb) etc., and is not limited thereto.

Lastly, each wireless AP 22, 32, 42, 52, 62 having the bandwidth sharing protocol enabled within a specific distance joins the same sharing group G1 (step S14). As the embodiment mentioned above, Different from each wireless AP 22, 32, 42, 52, 62, either the seventh wireless AP 72 is in a distant location or does not have the bandwidth sharing protocol enabled, the seventh wireless AP 72 does not join the sharing group G1 and does not perform the method of present.

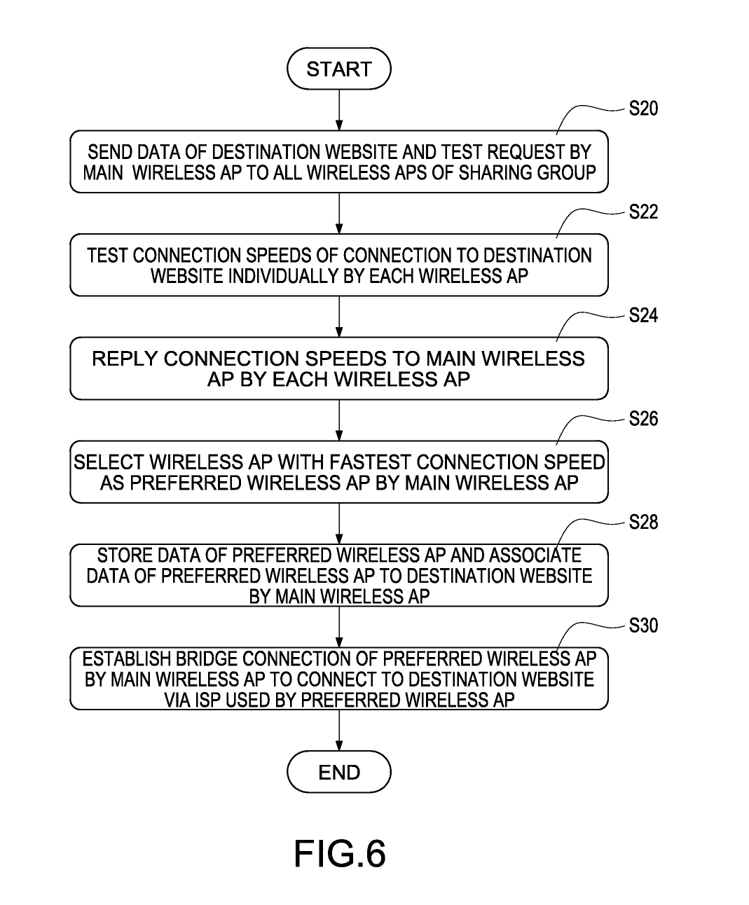

FIG. 6 is a flowchart according the second embodiment of the present invention. When users want to connect to the destination website 6, an electronic device (such as a desktop computer, a tablet, a notebook computer, or a smart phone) is used for wirelessly accessing to a main wireless AP (for example, the main wireless AP is the second wireless AP 22 in FIG. 3) to connect to the internet via the main wireless AP.

Before connecting to the destination website 6, the main wireless AP sends the data of the destination website 6 and a test request to all wireless APs 22, 32, 42, 52, 62 joining the sharing group G1 (step S20). In other words, the main wireless AP sends the data of the destination website 6 and the test request to the wireless APs 22, 32, 42, 52, 62 having the bandwidth sharing protocol enabled within the specific distance. The data of the destination website 6 includes internet protocol (IP) of the destination website 6, and is not limited thereto.

Next, each wireless AP 22, 32, 42, 52, 62 joining the sharing group G1 which receives the test request individually test the connection speeds of the connection to the destination website 6 (step S22). The above mentioned connection speeds refers to connection speeds of the connection to the destination website 6 via the ISP used by each wireless AP 22, 32, 42, 52, 62.

After the testing at the step S22, each wireless AP 22, 32, 42, 52, 62 replies the connection speeds to the main wireless AP (step S24). The main wireless AP selects a wireless AP from the sharing group G1 which has the fastest connection speed as a preferred wireless AP (step S26). For example, the third wireless AP 32 is the preferred wireless AP in FIG. 3.

It should be mentioned that, the main wireless AP directly stores the data of the preferred wireless AP and associates the data of the preferred wireless AP to the destination website 6 after the step S26 in order to save testing time and quickly connect to the destination website 6 when the users want to visit the destination website 6 in the future (step S28). Nonetheless, the step S28 is provided for users' convenience when the users reconnect to the destination website 6 and is not a mandatory step in the method of establishing a bridge connection according to the present invention.

When the main wireless AP selects the preferred wireless AP in the sharing group G1, the main wireless AP establishes a bridge connection of the preferred wireless AP to connect to the destination website 6 via the ISP used by the preferred wireless AP (step S30). As mentioned above, If the third wireless AP 32 is the preferred wireless AP in the embodiment, the ISP used by the preferred wireless AP is the third ISP 34. After the step S30, the second wireless AP 22 establishes a bridge connection to the third wireless AP 32 to connect to the destination website 6 via the third ISP 34.

With the steps mentioned above, either under the circumstance the bandwidth of the ISP used by the main wireless AP is insufficient, or the connection speed of the connection provided by the ISP to the destination website 6 is slow, the main wireless AP can establish a bridge connection with the preferred wireless AP to connect to the internet via the ISP used by the preferred wireless AP once the connection speed of the main wireless AP is slower than the connection speed of the preferred wireless AP. Thus, users are provided with the fastest connection speeds anywhere anytime without accepting the connection speed provided by the contracted ISP, which is convenient to users.

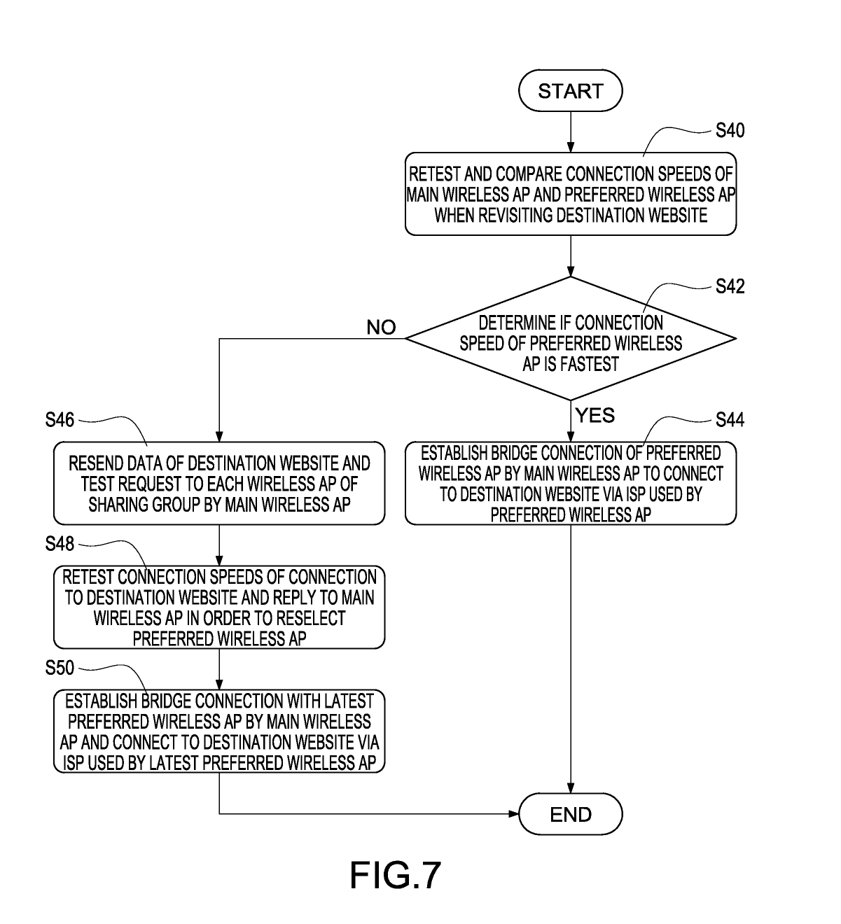

FIG. 7 is a flowchart seventh according the third embodiment of the present invention. The connection speeds provided by each ISP change and are subject to connection time period, geographic locations, IP addresses of the destination website. In other words, the preferred wireless AP selected by the main wireless AP in connecting to one particular website may not be the wireless AP having the fastest connection speed when connecting to the other website. Therefore, the steps of the embodiment in the above are performed before the main wireless AP connects to different websites in order to assure the connection speed provided is the fastest.

In addition, when connecting to the same destination website 6, the preferred wireless AP selected by the main wireless AP in a particular time period may not be the wireless AP having the fastest connection speed when connecting in the other time period. Therefore, the step can move to retest and compare the connection speeds of the main wireless AP and the preferred wireless AP when revisiting the destination website 6 (step S40). Next, the step move to determine if the connection speed of the preferred wireless AP is the fastest (step S42).

In the step S42, if the connection speed of the preferred wireless AP is determined to be the fastest, the main wireless AP stores the data of the preferred wireless AP and establishes a bridge connection to the preferred wireless AP to connect to the destination website 6 via the ISP used by the preferred wireless AP (step S44).

In the step S42, the method moves to determine if the connection speed of the preferred wireless AP is not the fastest. If yes, the main wireless AP resends data of the destination website 6 and the test request to each wireless AP 22, 32, 42, 52, 62 of the sharing group G1 (step S46). The wireless APs 22, 32, 42, 52, 62 joining the sharing group G1 retest the connection speeds of the connection to the destination website 6 and reply to the main wireless AP in order to reselect a wireless AP as the latest preferred wireless AP (step S48).

At last, the step move to establish a bridge connection with the latest preferred wireless AP by the main wireless AP and connect to the destination website 6 via the ISP used by the latest preferred wireless AP (step S50). Further, the main wireless AP stores the data of the latest preferred wireless AP replacing the data of the last preferred wireless AP. It should be mentioned that the main wireless AP can store data of multiple preferred wireless APs integrated with testing time slots for automatically establishing a bridge connection with the corresponding preferred wireless AP at different time periods, and is not limited thereto.

As the skilled person will appreciate, various changes and modifications can be made to the described embodiments. It is intended to include all such variations, modifications and equivalents which fall within the scope of the invention, as defined in the accompanying claims.

What is claimed is:

1. A method for establishing a bridge connection among wireless access points (APs), comprising:
a) sending data of a destination website and a test request by a main wireless AP to all wireless APs within a specific distance;
b) testing the connection speeds of the connection to the destination website individually and reporting the connection speeds to the main wireless AP by the wireless APs receiving the test request;
c) selecting the wireless AP having the fastest connection speed as the preferred wireless AP by the main wireless AP; and
d) bridging the main wireless AP with the preferred wireless AP and connecting to the destination website via the internet service provider (ISP) used by the preferred wireless AP.

2. The method for establishing a bridge connection among wireless access points of claim 1, wherein the data of the destination website is the destination website Internet Protocol (IP) address.

3. The method for establishing a bridge connection among wireless access points of claim 1, wherein the method further comprises a step e: storing the data of the preferred wireless AP by the main wireless AP, and connecting the data of the preferred wireless AP to the destination website.

4. The method for establishing a bridge connection among wireless access points of claim 1, wherein all wireless APs within the specific distance join the same sharing group.

5. The method for establishing a bridge connection among wireless access points of claim 4, wherein the wireless APs has bridge function and has a bandwidth sharing protocol, and the method further comprises following steps before the step a:
a01) enabling the bandwidth sharing protocol by the wireless APs individually; and
a02) joining the sharing group by each wireless AP with the bandwidth sharing protocol enabled.

6. The method for establishing a bridge connection among wireless access points of claim 5, wherein the method further comprising a step a03 after the step a01 and before the step a02:
setting up the sharing profile by the wireless APs individually.

7. The method for establishing a bridge connection among wireless access points of claim 6, wherein the sharing profile is the sharing bandwidth percentage of the wireless AP.

8. The method for establishing a bridge connection among wireless access points of claim 6, wherein the sharing profile is sharing bandwidth traffic of the wireless AP.

9. The method for establishing a bridge connection among wireless access points of claim 4, wherein further comprising following step:
f) retesting and comparing the connection speeds of the connection to the destination website by the main wireless AP and the preferred wireless AP when revisit the destination website;
g) determining if the connection speed of the preferred wireless AP is the fastest; and
h) bridging with the preferred wireless AP by the main wireless AP to reconnect to the destination website via the ISP used by the preferred wireless AP if the preferred wireless AP has the fastest connection speed.

10. The method for establishing a bridge connection among wireless access points of claim 4, wherein further comprising following step:
i) retesting and comparing the connection speeds of the connection to the destination website by the main wireless AP and the preferred wireless AP when revisit the destination website;
j) determining if the connection speed of the preferred wireless AP is the fastest;
k) resending the data of the destination website and the test request to the wireless APs of the sharing group by the main wireless AP if the connection speed of the preferred wireless AP is not the fastest;
l) retesting the connection speeds of the connection to the destination website and reporting the connection speeds to the main wireless AP by each wireless AP as the reference to the main wireless AP for reselecting a preferred wireless AP; and
m) bridging with the latest preferred wireless AP by the main wireless AP to connect to the destination website via the ISP used by the latest preferred wireless AP.

11. A method for establishing a bridge connection among wireless access points based on a sharing group, wherein the sharing group comprises a plurality of wireless APs having bridge function and bandwidth sharing protocol, the method for bridge connection comprising:
a) sending the IP address of a destination website and a test request to all wireless APs of the sharing group by a main wireless AP of the sharing group;
b) testing the connection speeds of the connection to the destination website and reporting the connection speeds to the main wireless AP individually by the wireless APs of the sharing group;
c) selecting the wireless AP having the fastest connection speed as the preferred wireless AP by the main wireless AP; and
d) bridging the main wireless AP with the preferred wireless AP and connecting to the destination website via the internet service provider (ISP) used by the preferred wireless AP.

12. The method for establishing a bridge connection among wireless access points of claim 11, wherein further comprising a step e: setting up the sharing profile by the wireless APs individually.

13. The method for establishing a bridge connection among wireless access points of claim 12, wherein the sharing profile is the sharing bandwidth percentage of the wireless AP.

14. The method for establishing a bridge connection among wireless access points of claim 12, wherein the sharing profile is sharing bandwidth traffic of the wireless AP.

15. The method for establishing a bridge connection among wireless access points of claim 11, wherein the method further comprises a step f: storing the data of the preferred wireless AP by the main wireless AP, and connecting the data of the preferred wireless AP to the destination website.

16. The method for establishing a bridge connection among wireless access points of claim 11, wherein further comprising following step:
g) retesting and comparing the connection speeds of the connection to the destination website by the main wireless AP and the preferred wireless AP when revisit the destination website;
h) determining if the connection speed of the preferred wireless AP is the fastest;
i) bridging with the preferred wireless AP by the main wireless AP to reconnect to the destination website via the ISP used by the preferred wireless AP if the preferred wireless AP has the fastest connection speed;
j) resending the data of the destination website and the test request to the wireless APs of the sharing group by the main wireless AP if the connection speed of the preferred wireless AP is not the fastest;
k) retesting the connection speeds of the connection to the destination website and reporting the connection speeds to the main wireless AP by each wireless AP as the reference to the main wireless AP for reselecting a preferred wireless AP; and
l) bridging with the latest preferred wireless AP by the main wireless AP to connect to the destination website via the ISP used by the latest preferred wireless AP after step k. 12.

17. A method for establishing a bridge connection among wireless access points based on a sharing group, wherein the sharing group comprises a plurality of wireless APs having bridge function and bandwidth sharing protocol, the method for bridge connection comprising:
a) receiving the IP address of a destination website and a test request at each wireless AP of the sharing group;
b) testing the connection speeds of the connection to the destination website individually at the wireless AP according to the test request;
c) reporting the connection speeds to the main wireless AP sending the test request individually at each wireless AP, wherein the main wireless AP is one of plurality of the wireless APs in the sharing group;
d) storing the data of the wireless AP having the fastest connection speed for selecting the wireless AP as the preferred wireless AP by and connecting the data of the preferred wireless AP to the destination website; and
e) bridging the main wireless AP with the preferred wireless AP and connecting to the destination website via the internet service provider (ISP) used by the preferred wireless AP.

18. The method for establishing a bridge connection among wireless access points of claim 17, wherein further comprising a step f: setting up the sharing profile by the wireless APs individually.

19. The method for establishing a bridge connection among wireless access points of claim 18, wherein the sharing profile is the sharing bandwidth percentage of the wireless AP.

20. The method for establishing a bridge connection among wireless access points of claim 18, wherein the sharing profile is sharing bandwidth traffic of the wireless AP.
